(19) United States
(12) Patent Application Publication
(10) Pub. No.: US 2007/0263590 A1
(43) Pub. Date: Nov. 15, 2007

(54) OPTIMIZATION SCHEME FOR ROUTING BASED ON DATA LATENCY

(75) Inventors: Shahaf Abileah, Seattle, WA (US); Jeffrey D. Couckuyt, Bothell, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/380,167

(22) Filed: Apr. 25, 2006

(51) Int. Cl. H04L 12/28

(52) U.S. Cl. 370/351

(57) ABSTRACT

The subject disclosure pertains to systems and methods for optimizing generation of routes within a topology by providing for latency during data retrieval. Frequently, topologies are maintained in multiple data stores, such as cache, local data stores and remote data stores. Delays due to latency in retrieving data from the various data stores can be mitigated by immediately processing available edge data rather than waiting for requested edge data to become available. A list can be provided for tracking edges that have been partially processed. As topology data from data stores with slower data retrieval rates is received, additional edges become available for processing and the list of partially processed edges can be updated.

### BACKGROUND

Routing engines and algorithms can be used to determine an optimal or preferred route between a start node and an end node within a topology or graph. Frequently, routing engines are used to generate a route between a first geographical location and a second location represented as nodes in the graph, through a series of edges representing streets or roads. Users can be presented with a map indicating the generated route or a set of directions designed to assist the user in following the route from the first location to the second location. However, routing problems are not limited to geographic or mapping contexts. Routing engines can be utilized whenever a solution to a problem can be represented as a path between two or more nodes in a graph. For example, routing engines can be used in a computing network environment, where terminals (e.g., personal computers, servers, peripheral devices and wireless devices) can be represented as nodes and wired or wireless connectivity can be represented by edges within the topology.

Routing engines can be used to generate routes through large, complex topologies. For example, the volume of geographical information that can be represented by a graph or topology is immense. Within the United States of America alone, there are millions of addresses, streets and other geographical objects. Routing engines can navigate this vast geographical data set to generate a route connecting a first location with a second location or linking a series of locations.

Information seekers can utilize routing engines either in a local computing environment, where the topology is maintained locally, or in a network environment, including both wired and wireless networks. In a network environment, portions of the topology can be downloaded to the local environment for processing. Accessing a topology via a network can be particularly useful in the geographic context, where users can utilize a mobile device (e.g., a smartphone, a personal digital assistant (PDA) or a vehicle navigation system) to connect to a server and generate routes based upon the user's current location.

The speed of route generation can be critical to users, particularly within the geographic context. Users are frequently hurried and rapid generation of routing information can be crucial. For example, a user who is running late for a meeting and has taken a wrong turn requires routing information immediately. In general, users are likely to become quickly frustrated with a routing engine that is incapable of generating and supplying routes expeditiously.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns the optimization of routing engines or methods to compensate for latency in retrieval of data. Frequently, topologies or graphs include large volumes of data, such as geographic data. Consequently, not all topology data may be available at the same rate of retrieval. For example, a subset of the data may be stored in cache, while the remainder of the topology data can be stored in local and/or remote data stores. Generally, the data access rate for cache is significantly faster than data access rates for either local or remote data stores. Delays due to latency in data retrieval can be mitigated by modifying the edge processing order to process immediately available edge data rather than remaining idle, waiting for requested edge data to become available.

To compensate for data latency and control the processing of edges, a list or other data structure can be used to track edges that have not yet been fully explored due to delays in obtaining requested data. Edges that cannot be totally and immediately explored are added to this list of partially processed edges. A separate list can be used to keep track of edges that are readily available for processing. Edges from the list of available edges are processed during route generation. As topology data from data stores with slower data retrieval rates is received, additional edges become available for processing and can be added to the list of available edges. Consequently, route generation can be optimized by processing available edges rather than waiting for data to be retrieved from slower data stores.

Termination conditions can be used in combination with the data latency optimization. Due at least in part to the reorganization of processing order to provide for data latency, the optimal route may not be the first route found. By combining termination conditions such as time constraints with this reorganization of processing order, the process can be terminated once a solution, although not necessarily the optimal solution, has been found.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system for generating a route connecting nodes in a topology in accordance with an aspect of the subject matter described herein.

FIG. 2 is a block diagram of a system for providing a route to an interface in accordance with an aspect of the subject matter described herein.

FIG. 3 is a block diagram of a system for generating routes in accordance with an aspect of the subject matter described herein.

FIG. 4 illustrates a method for route generation in accordance with an aspect of the subject matter described herein.

FIG. 5 illustrates an optimized method for route generation in accordance with an aspect of the subject matter described herein.

FIG. 6 illustrates a method for processing data received after a delay in accordance with an aspect of the subject matter described herein.

FIG. 7 illustrates a method for processing an edge in accordance with an aspect of the subject matter described herein.

FIG. 8 illustrates a method for evaluating an edge in accordance with an aspect of the subject matter described herein.

FIG. 9 is a schematic block diagram illustrating a suitable operating environment.

FIG. 10 is a schematic block diagram of a sample-computing environment.

### DETAILED DESCRIPTION

The various aspects of the subject invention are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. The subject matter disclosed herein is not limited by such examples. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope or spirit of the claimed subject matter.

For routing problems, a problem space can be represented as a set of nodes connected by a series of edges. In general, solutions to problems can be represented as a route or path connecting a first node and a second node. Generating paths or routes from one geographic location to another can be modeled as a routing problem. Typically, geographic data sets include vast amounts of data representing geographical features such as addresses and roads. Frequently, devices are unable to download or maintain an entire data set. Instead, such devices can support portions or subsets of the data set. Additional subsets or blocks of data can be retrieved as needed from one or more data stores. As used herein, a block of topology data is a subset of the topology data. Blocks are not limited to a particular size; however, for a given topology, data is frequently retrieved in consistently sized blocks. Block size can be based upon topology. For example, in a geographic context, a block can represent a fixed-sized geographic region (e.g., five square miles). Alternatively, a block can be based upon a set number of bytes of data (e.g., 1 MB). Topology data can be maintained in multiple data stores using a variety of devices or models.

A variety of models and organizational schemes including, but not limited to quad-trees and R-trees can be used to store topology data such as geographic data. The goal of these organizational schemes is to manage a large number of geographic features (e.g., roads, landmarks) such that features located in a specific geographic area can be quickly located. Typically, such organizational schemes achieve this by dividing the geographic data into blocks, where a block contains spatially proximate geographic features. For example, the quad-tree scheme divides the geographic region into a set of grids and classifies each geographic feature into a single block. If a geographic feature extends across the grid boundary, the feature can be subdivided into individual portions that are completely encompassed by a grid. When using this organizational scheme, if data for an edge is requested, the entire grid encompassing the edge is retrieved.

In general, data can be downloaded into the most readily accessible data store as needed. If edges to be explored by the routing engine are available within the block or blocks of data maintained by the most readily accessible data store, the processing algorithm can respond rapidly. However, during generation of a route, the routing engine may elect to explore edges or nodes that are not contained within the topology data stored in the most immediate memory. In this case, one or more additional blocks of data can be retrieved from slower data locations.

Typically, routing engines are unaware of the location in which data is stored and therefore do not manage or optimize processing based upon data availability. Instead, the routing engine may remain idle, waiting for certain data to be retrieved from a slower data store even when there is other useful data available for processing within the most readily accessible memory. To optimize performance of a routing engine, edges that require retrieval of additional topology data can be tracked. While additional topology data is being retrieved, available data can be processed. As the data is retrieved, it can be added to an ordered list of data available for processing. The problems with respect to data latency have been described with respect to a quad-tree scheme; however, such problems as well as the system and methods described herein for mitigating such problems are not limited quad-tree scheme and R-tree schemes. This optimization is applicable to any data organization scheme in which the data is retrieved in chunks or blocks.

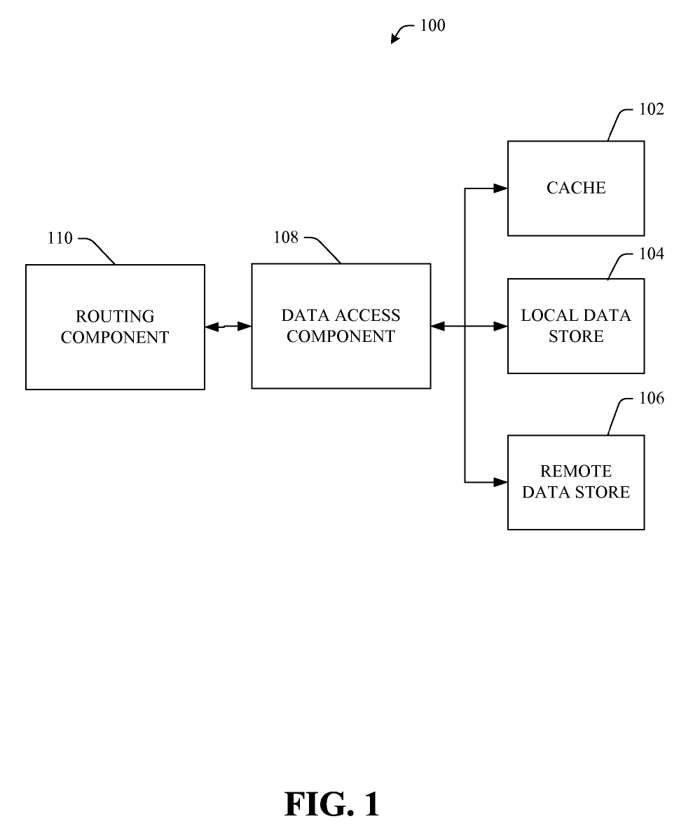

Referring now to FIG. 1, a system 100 for generating a path or route connecting nodes in a topology or graph is illustrated. Topology data can be stored using one or more types of available data stores. For example, the system 100 can include a cache 102. In general, routing or mapping systems have finite resources including a quick access cache 102. A small amount of the topology data can be stored in cache 102, available for quick access. The system 100 can also include one or more local data stores 104 (e.g., a magnetic disk or flash memory). In general, a larger amount of topology data can be maintained in a local data store 104 than in cache 102; however, it can take longer to access topology data maintained by a local data store 104 than to access data stored in cache 102. In addition, the system 100 can include one or more remote data stores 106. The remote data store 106 can contain an even larger portion of the topology data, but is generally slower to access than either cache 102 or local data stores 104. For example, a remote data store 106 can be implemented as a database on a remote device, such as a server available over the Internet. A single cache 102, local data store 104 and remote data store 106 are depicted here for simplicity. However, multiple instances of each data store type can be utilized. In addition, each instance can be implemented using different devices having distinct data retrieval rates. For example, the system 100 can include a local data store 104 implemented using a magnetic disk as well as a local data store 104 implemented using flash memory. In addition, some or all of the topology data can be compressed to minimize storage requirements. Data decompression can also increase the retrieval time for compressed blocks of topology data.

The system 100 can include a data access component 108 responsible for retrieving topology data from at least one of cache 102, local data store 104 and remote data store 106. Typically, the cache 102, local data store 104 and remote data store 106 form a hierarchy. Generally, cache 102 includes a subset of the data maintained within the local data store 104. The local data store 104 in turn includes a subset of the data maintained within the remote data store 106. The data access component 108 can retrieve blocks of topology data from any of the cache 102, local data store 104 and remote data store 106. In general, data that is more likely to be utilized should be copied from the remote data store 106 to the local data store 104 and data that is most likely to be utilized should be copied into cache 102.

In addition, the system 100 can include a routing component 110 that generates routes or paths between nodes within the topology. To generate a path, the routing component 110 can request the relevant topology data from the data access component 108. In response to the request from the routing component 110, the data access component 108 can retrieve or obtain the relevant block of topology data from cache 102, the local data store 104 or the remote data store 106.

Frequently, multiple paths can be generated connecting a pair of nodes. Selection of a preferred or optimal path can be based upon values, weights or costs associated with the edges that make up the path. A path can be chosen to minimize the total cost of the edges included in the path. Preferred paths or edges can be selected based upon varied criteria. For example, within the geographic mapping context, metadata associated with the edges (e.g., speed limits, mileage, pavement type and road type) can be used to determine a cost associated with each edge. A path can be selected so as to minimize the cost of navigating the topology between the selected nodes, where the cost of a path can be calculated as the sum of the edges included in the path.

The speed at which the relevant topology data becomes available to the routing component 102 can vary depending upon the data store from which the topology data is obtained. Typically, routing components 110 remain idle while waiting for the topology data requested from the data access component 108. However, performance can be enhanced by optimizing path generation, such that while topology data is being retrieved from slower data stores, the routing component continues to process readily available topology data. The routing component 110 can continue to request and receive topology data from more responsive data stores via the data access component 108 while waiting for topology data from a data store with slow accessibility.

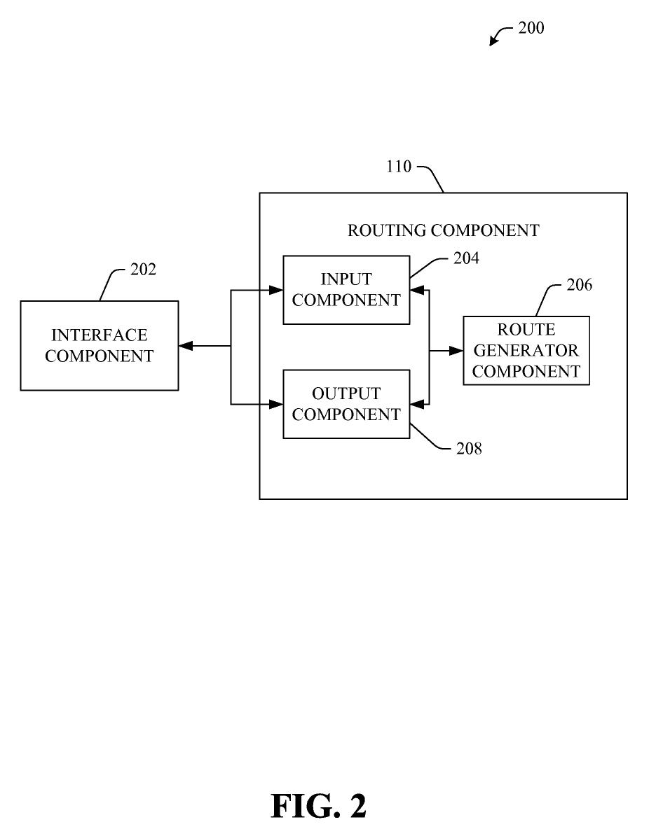

Referring now to FIG. 2, a system 200 for providing routes or paths is illustrated. The system 200 can include an interface component 202 that utilizes routes generated by the routing component 110. An interface component 202 can include mapping or direction generation applications, user interfaces or other applications that utilize routes. In particular, an interface component 202 can be accessible using mobile devices (e.g., a vehicle navigation system, a PDA, a smartphone or other handheld device). Interface components 202 can utilize the routing component 110 to generate a single route for a single user or to generate multiple routes for use by a fleet of vehicles. A single interface component 202 is illustrated here for simplicity; however, the system can include multiple interface components 202.

The interface component 202 can specify a start and end node to generate a path or route. For example, the interface component 202 can request a route connecting a first location corresponding to the start node to the second location corresponding to the end node. The start and end nodes can be designated as an origin and destination, respectively, to indicate the direction of traversal of the topology. Direction of traversal can effect selection of a route depending upon edge constraints. For example, within the geographic context, one-way streets can be considered constrained edges. A route including a one-way street would be unavailable if the direction of traversal were reversed. In addition, the interface component 202 can specify multiple nodes or points along the route as well as an order of nodes within the route. For example, a user can request a route from the user's home to the local school to pick up their children and then on to a local park for a soccer game.

The interface component 202 can provide route specifications to the input component 204. The interface component 202 can specify the topology to be utilized. The routing component 110 can be capable of generating routes for multiple topologies. The interface component 202 can indicate to the routing component 110 the topology to be traversed during a specific route generation. For example, the routing component 110 can utilize a topology containing street information for a user in an automobile and a separate railway specific topology to generate routes using the rail system for a user utilizing public transportation. The input component 204 can also receive information from the interface component 202 regarding routing preferences. For example, a user may have a fear of highway driving, tunnels and bridges or the user may wish to avoid paying tolls. Routes should be generated in accordance with these routing preferences. In this example, an optimal route avoiding or minimizing use of highways, tunnels, bridges and toll roads should be generated. The input component 204 can also validate the received data. For example, the input component 204 can confirm that the topology is available and that the selected nodes are included in the selected topology.

Routes can be generated by a route generator component 206. The route generator component 206 can utilize an optimized algorithm based upon any of a variety of routing algorithms (e.g., A* or Djikstra's algorithm) to discover a path or route connecting the selected nodes. In general, routing algorithms assume that the topology data is available at hand. However, the routing generator component 206 can be optimized to handle data latency and minimize delay due to data retrieval latency.

In general, route generating algorithms such as A* determine an optimal path between nodes by starting at the first node and crawling outward, investigating all edges connected to the nodes. Alternatively, the routing algorithm can include a bidirectional search, starting at both the first node and the second node simultaneously. A bidirectional search can be illustrated as two circles, one centered at the first node and the other at the second node. The radii of the circles grow as additional edges are investigated. The point where the circles intersect can represent an optimal route between the first node and second node. In general, the algorithm expands outward from the first node and/or second node through the topology. Typically, the next edge to be investigated is selected without regard to whether the edge is encompassed by the portion or block of topology data that is readily available. Route generation can halt for a significant period of time while waiting for topology data to be retrieved. This time can be used to investigate alternative edges that are readily available. The optimized route generator component 206 can utilize the delay due to data retrieval to process alternate, available edges.

Once a route has been generated, an output component 208 can return the route to the interface component 202. The output component 208 can format the generated route for use by the interface component 202. The interface component 202 can utilize the route in any manner. For example, the interface component 202 can provide a graphic user interface (GUI) and present the route or routes to a user in any format useful to the user. Routes can be illustrated using figures or maps. In addition, the interface component 202 can generate a set of directions that can be used to follow the route. The directions can be presented either visually or in audio format to the user. The presentation or use of generated routes is not limited by the preceding examples.

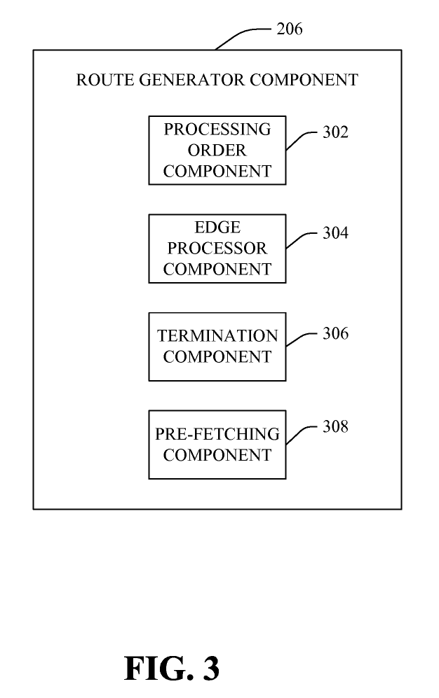

Referring now to FIG. 3, a route generator component 206 is illustrated in detail. The route generator component 206 can include a processing order component 302 that manages one or more queues, lists or other data structures used to track or manage the edges and control processing order. Typically, routing algorithms such as A* or Djikstra's algorithm utilize an “open list” of edges that are to be processed and a “closed list” of edges that have been fully processed. The processing order component 302 can manage an open list and closed list to control edge processing. In addition, the processing order component 302 can maintain a “partially processed list” of edges. Edges included in the partially processed list cannot be completely investigated because data regarding edges to which the current edge is connected is not fully available. As data becomes available, the newly available edges can be added to the open list. Once all edges connected to an edge on the partially processed list are retrieved, the edge can be moved to the closed list. In the interim, the route generator component 206 can process those edges for which all necessary data is currently available. The open list, closed list and partially processed list have been described as lists or queues. However, alternative methods of storing or managing data items can be used to manage information regarding edges that are available to be processed, have been processed or are partially processed.

The route generator component 206 can include an edge processor component 304. The edge processor component 304 can evaluate each edge for inclusion in a route. In addition, the edge processor component 304 can determine the cost associated with a route from the start node to a specific edge. The route or partial route cost is generally the sum of the costs associated with each edge included in the route.

The route generator component 206 can also include a termination component 306. The termination component 306 can determine when certain termination conditions have been met. When the termination conditions are met, route generation can be halted even if not all the edges have been processed or a possible route has not yet been found. Termination conditions can include predetermined, fixed time limits and minimum route requirements.

Termination conditions can provide for a maximum amount of time for edge processing and route generation. Users can be provided with a method for specifying a maximum amount of time that they are willing to wait for a route to be generated. The maximum time limit can be set such that route generation halts after the fixed amount of time regardless of whether any route connecting the selected nodes has been found. Alternatively, the maximum time limit can be dependent upon the generation of a possible route. For example, if a possible route has been found by the time limit, route generation can be halted whether or not the route is determined to be the best possible route between the selected nodes. However, if no route has been located by the time limit, route generation can continue either indefinitely or until a second final time limit has expired.

Utilizing time limits in combination with the partially processed list provides an option for terminating route generation early when a route (not necessarily the best route) is generated. When a route is located there can still be additional edges to be processed stored in the partially processed list. A better route might be generated by exploring the edges of the partially processed list. However, time limits or constraints can be used to accept the current route rather than to keep processing. Consequently, a time limit can be used in combination with the partially processed list to select a quickly generated route, whether or not it is the optimum route.

In addition, certain minimum route quality thresholds or standards can be set and used to terminate route generation prior to retrieval of the optimum route. For example, the termination conditions can specify acceptance of the first route found where the majority of the edges indicate highway driving. Once a route is accepted, route generation terminates. The time thresholds and route quality thresholds can be determined either by the route generator component 206 or an interface component.

In addition, the route generator component 206 can include a pre-fetching component 308. The pre-fetching component 308 anticipates the topology data that will be requested in the near future and obtains the topology data before the route generator component 206 begins to process edge data encompassed within the retrieved topology data. The pre-fetching component 308 can infer the likelihood of certain blocks of data being requested for route generation. The pre-fetching component 308 can also include a machine learning system that can be trained to request data, so as to optimize the amount of relevant data readily available for route generation.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. For example, the pre-fetching component described with respect to FIG. 3 can include artificial intelligence or rule based components or methods used to select the appropriate blocks of data to request.

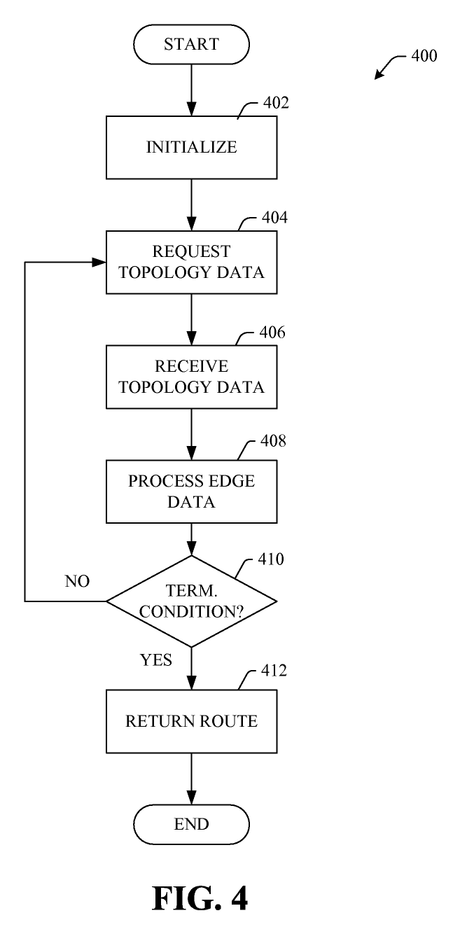

In view of the exemplary systems described supra, methodologies that may be implemented in accordance with the disclosed subject matter will be better appreciated with reference to the flowcharts of FIGS. 4-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

Referring now to FIG. 4, a methodology 400 for generating a route is illustrated. At 402, route generation is initialized. During initialization, parameters for generating a route can be obtained. For example, information regarding the desired start and end nodes of the route is obtained. In addition, if more than one topology is available for traversal, the topology to be traversed can be specified during initialization. Alternatively, the topology can be selected from one or more available topologies based upon the specified start and end nodes. For example, available topologies can be searched for the start and end nodes. A topology including the specified nodes can be utilized to generate a route connecting the nodes. Additional parameters obtained during initialization can include routing preferences. For example, the user may prefer the shortest physical route between the nodes or the route with the shortest projected travel time. Users may also wish to avoid certain types of edges such as highways, tunnels, bridges, etc.

At 404, topology data can be requested. The topology data can be requested based upon connectivity to the start and/or end node. The route can be generated by traversing edges outward from the start node, the end node or both the start and end node. At 406, topology data can be received in response to the request for topology data. Blocks of topology data can be received at differing times based upon data retrieval latency. The amount of data retrieved at any one time can be limited based upon available capacity of accessible data stores.

As the edge data contained within the topology data becomes available, edge data can be processed at 408. Processing an edge can include determining the total cost of the route from the start node or edge to the current edge, determining if a path to reach the current edge has already been found with a lower cost and predicting the remaining cost of a route from the current edge to the end node. Edges can be selected for inclusion in possible routes based at least in part upon costs associated with the edges.

At 410, a determination is made as to whether any termination conditions have been met. Termination conditions can include the generation of a route, the expiration of a predetermined time limit or a determination that there is no route connecting the start and end node. If termination conditions are not met, the process returns to 404 where additional topology data is requested. If one or more of the termination conditions are met, the result of route generation is returned at 412. The result can be either a route connecting the start and end nodes or an indication that no route connecting the start and end node was found. If no termination conditions were specified limiting route generation and no route was found, then no route exists within the topology to connect the start and end nodes. If a termination condition (e.g., a time limit) was specified and no route was found, a route may exist within the topology, but more time may be required to generate the route.

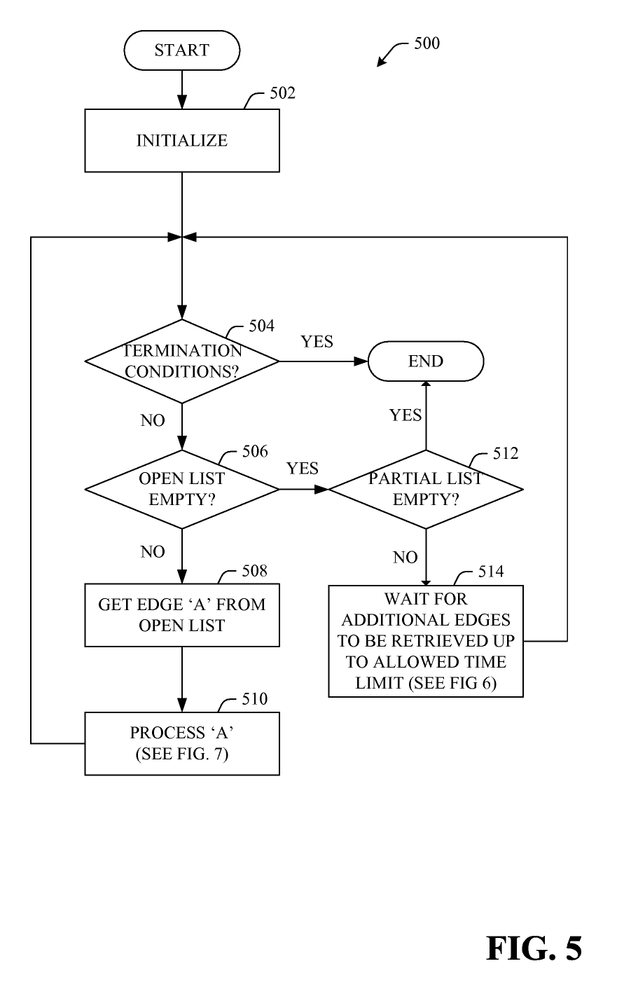

Referring now to FIG. 5, an optimized methodology 500 for generating a route is illustrated. At 502, the process is initialized. At initialization, all edges connected to the start edge can be added to an open list, indicating that those edges can be evaluated or processed during route generation. For example, in the geographic context if the starting location is an intersection, all roads at that intersection are added to the open list. If the starting location is not at an intersection, the closest intersection can be determined and all roads that pass through that closest intersection can be added to the open list.

At 504, a determination is made as to whether any termination conditions have been met. One possible termination condition can be generation of a route. For example, the first generated route can be accepted and returned. In addition, termination conditions can include expiration of a predetermined time limit whether or not a route has been generated. Other possible termination conditions can include exhaustion of allocated system resources, such as memory. Termination conditions can be specified by users or predetermined by the route generating process. If any of the termination conditions are met, the process ends and returns either a route or an indicator that no route was found.

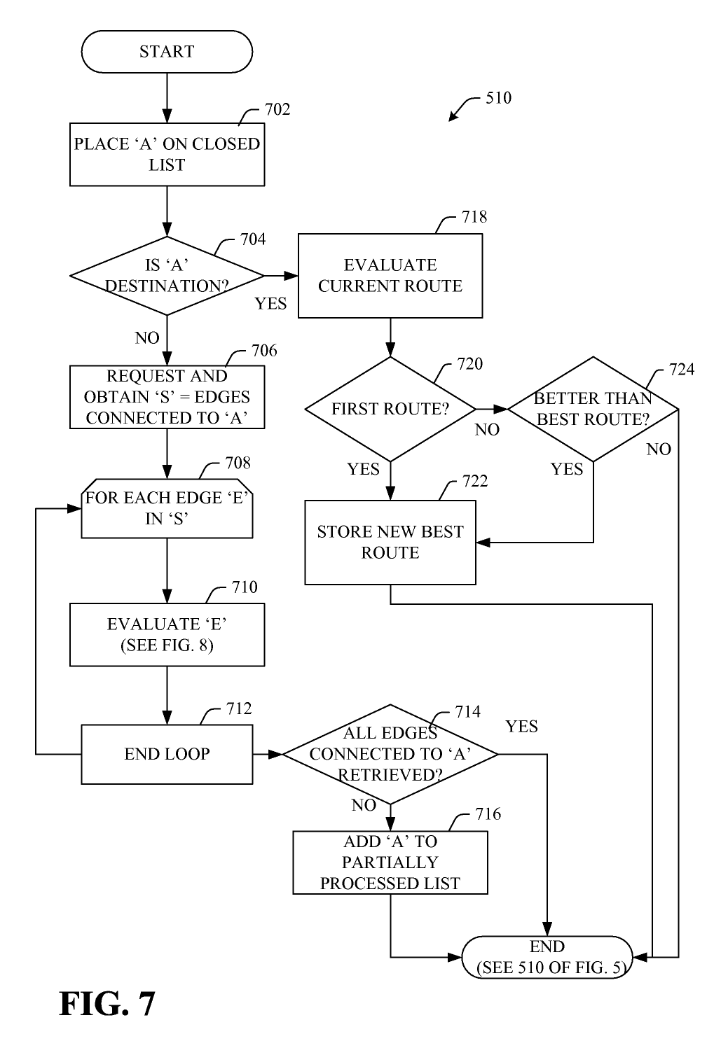

If the termination conditions are not met, at 506, a determination is made as to whether the open list is empty. The open list is unlikely to be empty immediately following initialization, but can become empty during processing. If a determination is made that the open list is not empty, an edge referred to herein as “A” is removed from the open list at 508. The open list can be a sorted list, organized based on costs associated with the edges. The edge, “A”, with the lowest associated cost can be removed from the list. At 510, edge “A” is processed. Edge processing is described in detail with respect to FIG. 7. After the edge “A” is processed, the method returns to 504, where a determination is made as to whether any termination conditions have been met, including generation of a route.

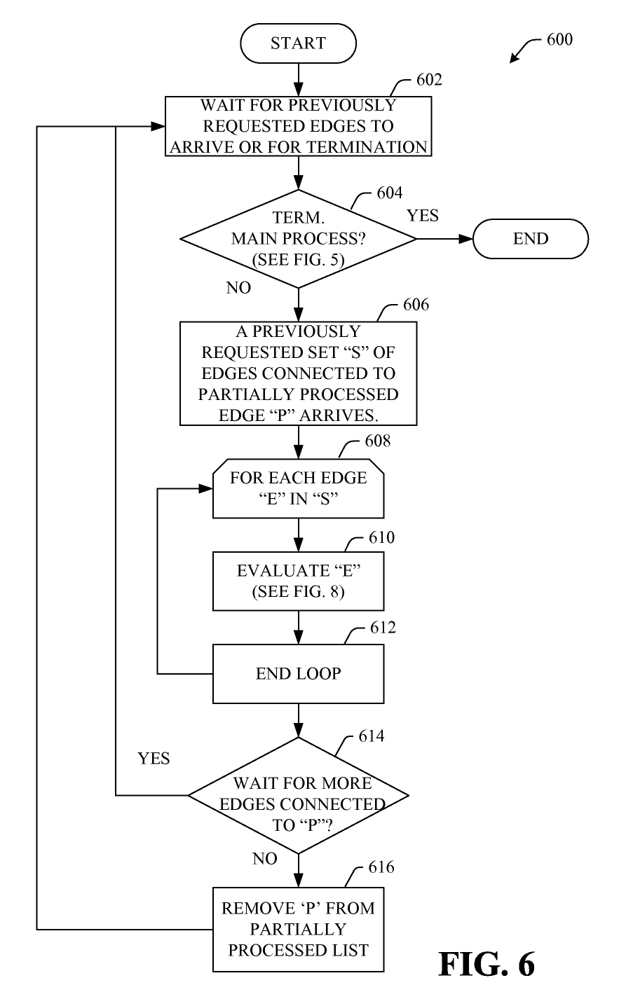

If it is determined that the open list is empty at 506 and all currently available edges have been processed, then a determination is made as to whether there are any edges in the partially processed list at 512. If there are no edges in the partially processed list either, then all edges in the topology have been processed, no route exists and the process ends. If yes, then at 514 the process waits until additional edge data is received or until expiration of a predetermined time limit. Waiting for additional edges can be handled by a second, background processing thread as described in further detail with respect to FIG. 6. Once additional edge data is received or time expires, the process returns to 504, where it is determined whether any of the termination conditions have been met.

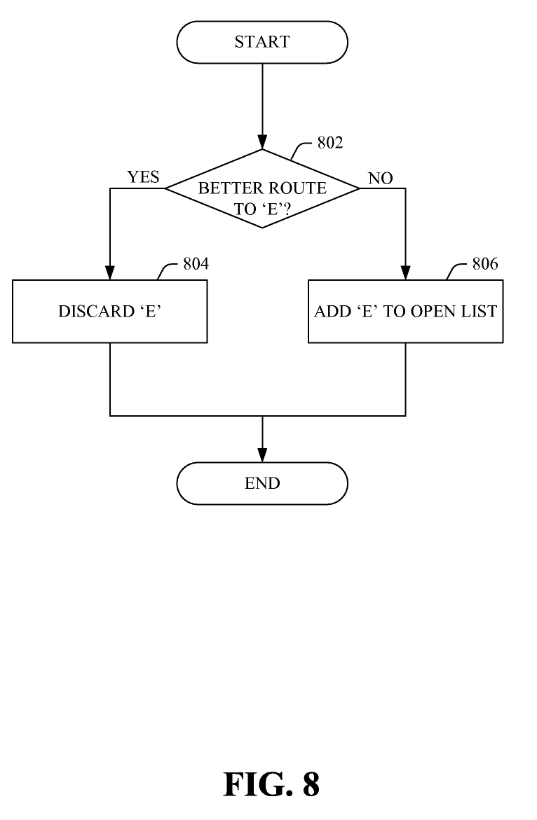

Referring now to FIG. 6, a methodology 600 for waiting for edges that are not immediately available is illustrated. When it is determined that topology data including a desired edge is not immediately available for processing, a separate thread of execution can be used to process edges that are not immediately available. At 602 the process waits until previously requested edges to become available or until the main process illustrated in FIG. 5 terminates. At 604, a determination is made as to whether the main process has terminated. If yes, the process ends. If no, at 606 the previously requested set of edges, “S”, connected to a partially processed edge, referred to as “P”, is received. At 608, a processing loop begins to process each edge “E” within the set of edges “S” received. An edge “E” is evaluated at 610. Edge “E” is evaluated to determine whether it is to be added to the open list. Evaluation of edge “E” is described in further detail with respect to FIG.8. The processing of the edges within set “S” terminates at 612.

At 614, a determination is made as to whether there are more edges connected to partially processed edge “P” for which the process is waiting. If yes, the process returns to waiting for additional requested edges or termination at 602. If no, partially processed edge “P” is removed from the partially processed list at 616 and the process returns to waiting for either additional requested edges or termination of the main thread at 602.

Referring now to FIG. 7, a methodology 510 for processing a single edge “A” retrieved from the open list is illustrated. At 702, edge “A” is placed on the closed list. At 704 a determination is made as to whether edge “A” is the destination edge. If yes, the process evaluates the possible route that has been generated. Evaluation of the route is discussed in detail below at 718. If edge “A” is not the destination edge, then at 706 the set of edges “S” connected to edge “A” are requested and obtained. At 708, a processing loop begins to process each edge “E” within the set of edges “S”. An edge “E” is evaluated at 710. Edge “E” is evaluated to determine whether it is to be added to the open list. Evaluation of edge “E” is described in further detail with respect to FIG.8. The processing of the edges with set “S” terminates at 712. At 714, a determination is made as to whether all edges connected to edge “A” have been retrieved. If yes, then processing of edge “A” terminates and route generation can continue at 510 of FIG. 5. If yes, then edge “A” is added to the partially processed list at 716, processing of edge “A” terminates and route generation can continue at 510 of FIG. 5.

Returning to 704, if edge “A” is a destination edge, the current route to destination edge “A” is evaluated at 718. Route evaluation can include generating a score based upon the edges that make up the route. At 720, a determination is made as to whether the current route is the first complete route to be generated. If the current route is the first route, the current route can be stored at 722. If at least one other route has been generated, a determination is made as to whether the current route is better than the pre-existing, best route at 724. If the pre-existing route is better than the current route, processing of edge “A” terminates and route generation can continue at 510 of FIG. 5. If the current route is better than the pre-existing best route, then the current route is saved as the best route, replacing the previous best route at 722. After the current route is stored, processing of edge “A” terminates and route generation continues at 510 of FIG. 5.

Referring now to FIG. 8, a methodology for evaluating an edge “E” to determine whether the edge is to be added to the open list of edges is illustrated. At 802, a determination is made as to whether a better route to edge “E” has already been found. For example, in the geographic context, there are typically multiple ways of reaching a street. A first route can utilize a highway, while a second route can include multiple local roads. The first route utilizing the highway can be considered preferable to the second route, depending upon the criteria used to evaluate the relative quality of various streets or edges. Accordingly, if a better route to edge “E” has been found, edge “E” is discarded and the evaluation process terminates. If a better route to edge “E” has not been found, the edge “E” is added to the open list of edges for possible processing at 806 and the evaluation process terminates.

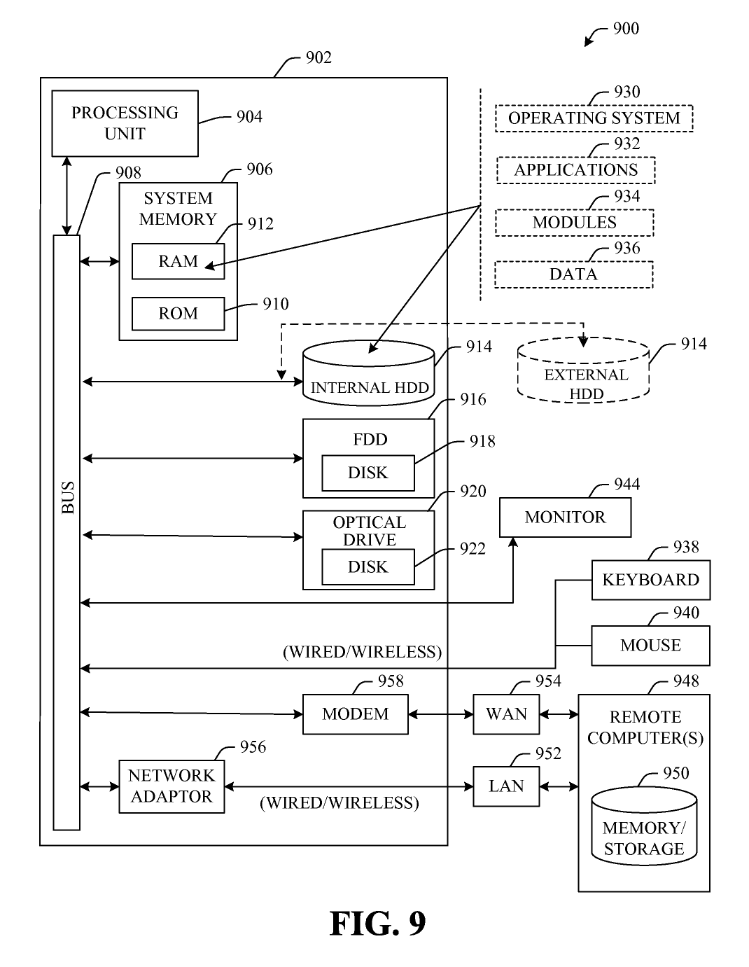

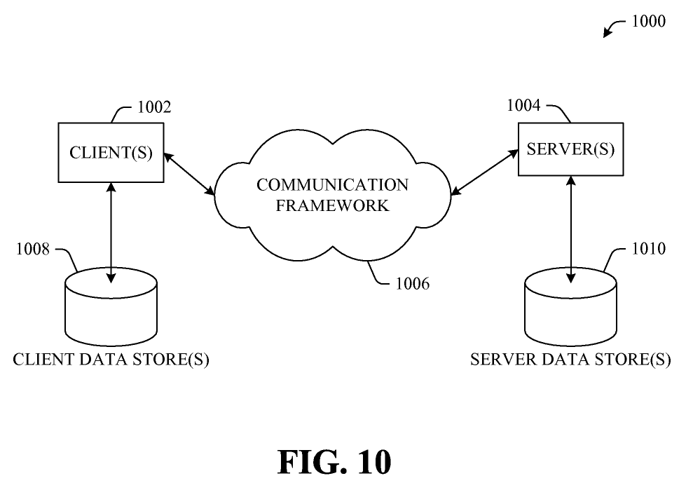

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference again to FIG. 9, the exemplary environment 900 for implementing various aspects of the embodiments includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data. Data maintained within cache for quick access can include topology data used for route generation.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be utilized as local data stores used to maintain topology data for use in route generation. The hard disk drive 914, magnetic disk drive 916 and optical disk drive 920 can be connected to the system bus 908.

The drives and their associated computer-readable media provide nonvolatile storage of data, data structures, computer-executable instructions, and so forth. The drives can provide for storage of instructions for generating routes as well as the topology data and any interface components that utilize routes generated by the route generator. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods for the embodiments of the data management system described herein.

A number of program modules can be stored in the drives and RAM 912, including an operating system 930, one or more application programs 932, such as interface component that utilize generated routes, other program modules 934 and program data 936. All or portions of the operating system, applications, modules, and/or data can also be cached in the RAM 912. It is appreciated that the systems and methods can be implemented with various commercially available operating systems or combinations of operating systems.

A user can enter commands and information into the computer 902 through one or more wired/wireless input devices, e.g., a keyboard 938 and a pointing device, such as a mouse 940 and numerous other input devices (not shown). A monitor 944 or other type of display device is also connected to the system bus 908. In addition to the monitor 944, a computer typically includes other peripheral output devices (not shown), such as speakers, printers, etc. The monitor 944 and other peripheral output devices can be used to present route information to a user.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The remote computer 948 can provide remote a local data store or stores. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface (not shown). In a networked environment, program modules depicted relative to the computer 902, or portions thereof, can be stored in the remote memory/storage device 950. It will be appreciated that the network connections shown are exemplary and other means of establishing a communications link between the computers can be used.

FIG. 10 is a schematic block diagram of a sample-computing environment 1000 with which the present invention can interact. The system 1000 includes one or more client(s) 1002. The client(s) 1002 can be hardware and/or software (e.g., threads, processes, computing devices). The system 1000 also includes one or more server(s) 1004. Thus, system 1000 can correspond to a two-tier client server model or a multi-tier model (e.g., client, middle tier server, data server), amongst other models. The server(s) 1004 can also be hardware and/or software (e.g., threads, processes, computing devices). One possible communication between a client 1002 and a server 1004 may be in the form of a data packet adapted to be transmitted between two or more computer processes. The system 1000 includes a communication framework 1006 that can be employed to facilitate communications between the client(s) 1002 and the server(s) 1004. The client(s) 1002 are operably connected to one or more client data store(s) 1008 that can be employed to store information local to the client(s) 1002. Similarly, the server(s) 1004 are operably connected to one or more server data store(s) 1010 that can be employed to store information local to the servers 1004. In one embodiment, server(s) 1004 can provide topology data to a route generating component at a client 1002.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system for facilitating the generation of a route of edges that connects a first node and a second node within a topology while mitigating latency in data retrieval, comprising:
a processing order component that receives at least one block of topology data and determines an edge processing order based at least in part upon latency in receiving topology data;
an edge processor component that processes at least one edge included in the block of topology data; and
a route generator component that generates a route of edges based at least in part upon the processed edge.

2. The system of claim 1, the processing order component maintains a set of partially processed edges and a set of edges to be processed.

3. The system of claim 1, further comprising:
a termination component that determines when a termination condition is met and concludes route generation based at least in part upon whether the termination condition is met.

4. The system of claim 3, the termination condition includes a time limit.

5. The system of claim 3, the termination condition includes a route quality threshold.

6. The system of claim 1, further comprising:
an input component that receives input specifying the first node and the second node; and
an output component that provides the route of edges to an interface component.

7. The system of claim 1, the topology is organized using at least one of a quad tree scheme and a R-tree scheme.

8. The system of claim 1, the at least one block of topology data is obtained from at least one of a remote data store and a local data store.

9. The system of claim 1, further comprising:
an interface component that provides a user interface to the route generator component, the interface component is accessible using a mobile device.

10. A method for facilitating generation of a path of edges connecting a first node and a second node within a graph while providing for delays in data retrieval, comprising:
requesting at least one block of graph data;
receiving at least one block, the at least one block includes at least one edge;
processing the at least one edge, order of edge processing is based at least in part on a retrieval rate associated with the at least one block; and
determining the path of edges based at least in part upon the processed edge.

11. The method of claim 10, further comprising:
maintaining a first set of edges for which data has been requested, but not received;
maintaining a second set of edges available for processing; and
removing the at least one edge from the first set when the requested data is received.

12. The method of claim 10, further comprising:
pre-fetching the at least one edge based upon an inference regarding the likelihood that the edge will be processed in the near future.

13. The method of claim 10, further comprising:
halting edge processing based at least in part upon a predetermined time limit.

14. The method of claim 10, further comprising:
halting edge processing based at least in part upon a predetermined time limit after generation of a possible path.

15. The method of claim 10, edge processing, further comprises:
determining a cost for the at least one edge, the cost is based at least in part upon a user preference, the path is determined based at least in part upon the cost of the at least one edge.

16. The method of claim of claim 10, the graph represents geographic data and the first node and second node represent geographic locations.

17. A system for facilitating generation of a route connecting a first node and a second node within a graph, comprising:
means for retrieving a block of graph data that includes at least one edge;
means for processing edges, edge processing order is based at least in part upon data latency in retrieval of the block of graph data; and
means for generating the route based upon the processed edges.

18. The system of claim 17, further comprising:
means for maintaining a first set indicating edges that are partially processed; and
means for maintaining a second set indicating edges that are to be processed.

19. The system of claim 17, further comprising:
means for pre-fetching a block of graph data.

20. The system of claim 17, further comprising:
means for terminating route generation conditioned at least in part on a predetermined time limit.
